(19) United States
(12) Patent Application Publication
(10) Pub. No.: US 2019/0114597 A1
(43) Pub. Date: Apr. 18, 2019

(54) METHODS FOR PREDICTIVE ESTIMATION OF REPAIR LINES BASED ON HISTORICAL DATA AND DEVICES THEREOF

(71) Applicant: Mitchell International, Inc., San Diego, CA (US)

(72) Inventors: Abhijeet Gulati, San Diego, CA (US); Ravi Nemani, Carlsbad, CA (US); Niv Genchel, San Diego, CA (US); Palak Samel, San Diego, CA (US); Don Carron, La Jolla, CA (US); Jason Farnsworth, San Diego, CA (US); Rahul Bhuwal, San Diego, CA (US); Christopher Allan, San Diego, CA (US); Kenny Crumpler, La Mesa, CA (US)

(21) Appl. No.: 16/162,025

(22) Filed: Oct. 16, 2018

Related U.S. Application Data
(60) Provisional application No. 62/573,020, filed on Oct. 16, 2017.

(51) Int. Cl. G06Q 10/00; G06K 9/00; G07C 5/08; G06Q 40/08

(52) U.S. Cl. CPC G06Q 10/20; G06Q 40/08; G07C 5/0808; G06K 9/00664

(57) ABSTRACT

A method, non-transitory computer readable medium and apparatus for providing predictive estimates of repair lines includes receives vehicle damage data including a plurality of images, videos, and vehicle diagnostic data. One or more damages are identified based on the received vehicle damage data. One or more repair parts data and labor data are determined for the identified one or more damages based on historical repair parts data and historical labor data. The determined one or more repair parts data and the labor data is provided via a graphical user interface.

This application claims the benefit of U.S. Provisional Patent Application Ser. No. 62/573,020, filed Oct. 16, 2017, which is hereby incorporated by reference in its entirety.

### FIELD

This technology generally relates to methods for predictive estimation of repair lines based on historical data and devices thereof.

### BACKGROUND

Providing an accurate estimate of the specific parts for repairing one or more defects from damage to a vehicle of a customer is important and challenging. It also is necessary to provide an accurate parts list on a timely basis in order to permit the customer to make a selection on whether or not to repair the defects.

Traditional methods for providing estimates have generally included, an inspector from a vehicle repair shop taking notes while inspecting the damages or defects of the vehicle. Next, the inspector may manually utilize reference materials, such as parts lists, manuals, handbooks or online databases, to identify a list of parts for repairing each of the defects. For a vehicle with multiple defects of different nature, such as coating defects, interior damages, or glass damages, the inspector has to locate the correct reference materials or databases by expending a significant amount of time and effort. Since different vehicles may require different repairing processes, repairing materials and labor, the inspector needs to generate information that is vehicle specific for coming up with an accurate list of the parts and labor required. This traditional process is laborious and time consuming and often leads to an inaccurate list of parts. To date there has been no technological solution to address this issue with accurately identifying the specific parts for a damaged vehicle without requiring user intervention.

### SUMMARY

A method for providing predictive estimates of repair lines includes receiving vehicle damage data including a plurality of images, videos, and vehicle diagnostic data. One or more damages are identified based on the received vehicle damage data. One or more repair parts data and labor data are determined for the identified one or more damages based on historical repair parts data and historical labor data. The determined one or more repair parts data and the labor data is provided.

A non-transitory computer readable medium having stored thereon instructions for providing predictive estimates of repair lines comprising executable code, which when executed by at least one processor, cause the processor to receive vehicle damage data including a plurality of images, videos, and vehicle diagnostic data. One or more damages are identified based on the received vehicle damage data. One or more repair parts data and labor data are determined for the identified one or more damages based on historical repair parts data and historical labor data. The determined one or more repair parts data and the labor data is provided.

A valuation management computing apparatus includes a memory coupled to the processor which is configured to be capable of executing programmed instructions comprising and stored in the memory to receive vehicle damage data including a plurality of images, videos, and vehicle diagnostic data. One or more damages are identified based on the received vehicle damage data. One or more repair parts data and labor data are determined for the identified one or more damages based on historical repair parts data and historical labor data. The determined one or more repair parts data and the labor data is provided.

Accordingly, this technology provides methods, non-transitory computer readable medium, and apparatuses that provide an automated accurate list of the specific parts required to fix the identified damages. Additionally, the disclosed technology is able to utilize diagnostic data obtained by sensors in the vehicle through the sensors and to identify and more accurately determines defects that may not be evidently visible to the eye. Once the defect(s) are identified, the disclosed technology automatically provides a list of the parts required to repair the defect(s) based on correlation with historical parts and the labor data.

### BRIEF DESCRIPTION OF THE DRAWINGS

FIG. 1 is a block diagram of an environment with an example of a valuation management computing apparatus that provides estimates of repair lines based on historical data;

FIG. 2 is a block diagram of the example of the valuation management computing apparatus shown in FIG. 1;

FIG. 3 is a flow chart of an example of a method for vehicle valuation utilizing automated integration of build sheet data;

FIG. 4 is a diagram of a first example of specific parts identified for a damaged vehicle;

FIG. 5 is a diagram of a second example of specific parts identified for a damaged vehicle;

FIG. 6 is a diagram of a third example of specific parts identified for a damaged vehicle; and

FIG. 7 is a diagram of a fourth example of specific parts identified for a damaged vehicle.

### DETAILED DESCRIPTION

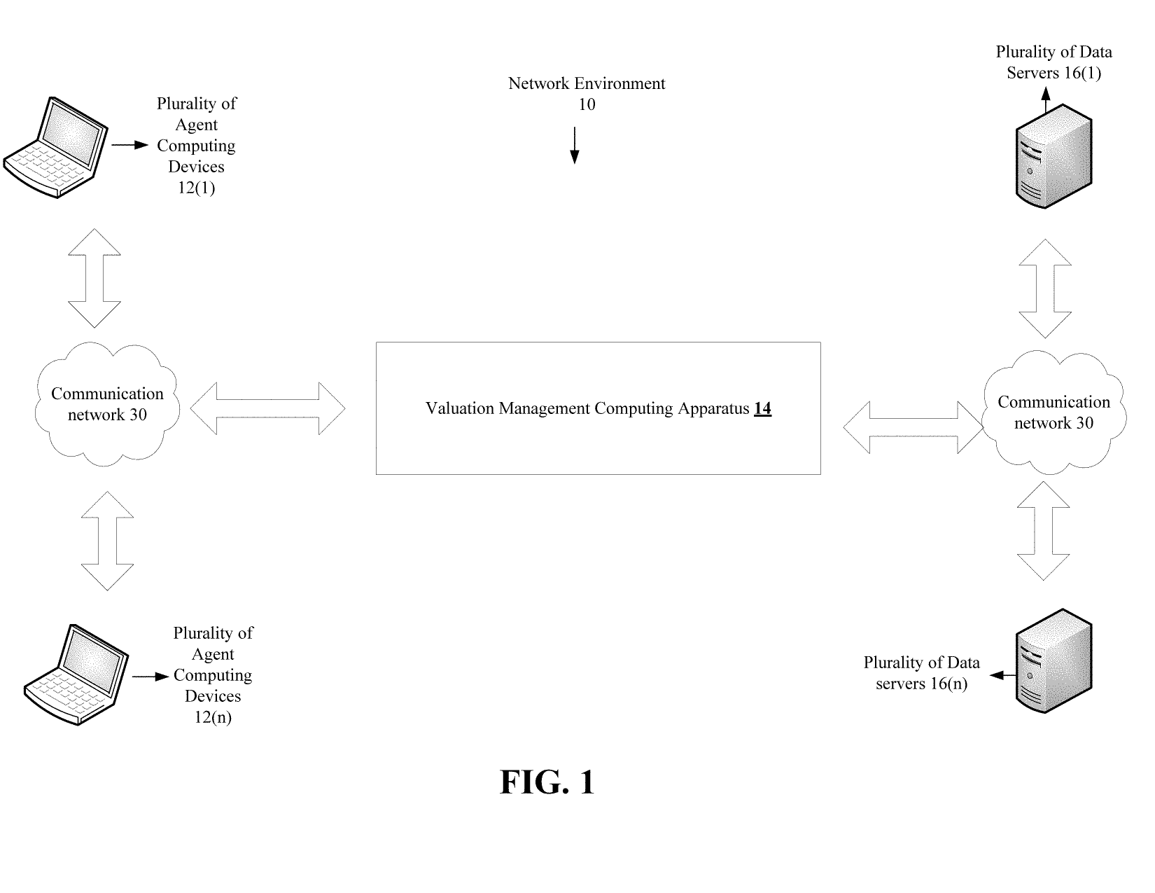

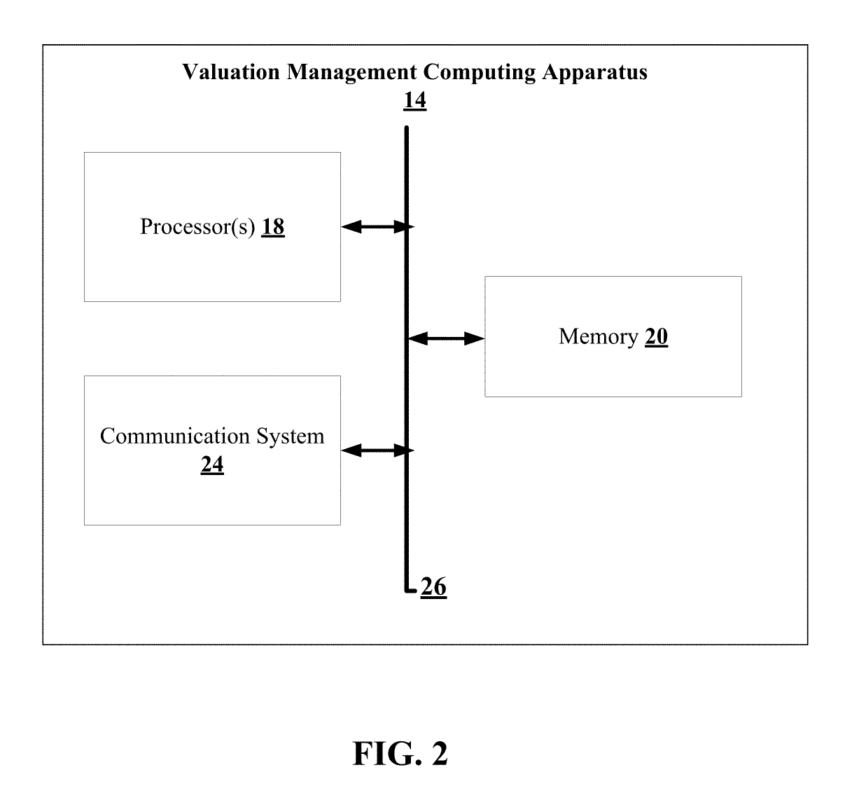

An environment 10 with an example of a valuation management computing apparatus 14 is illustrated in FIGS. 1-2. In this particular example, the environment 10 includes the valuation management computing apparatus 14, agent or other client computing devices 12(1)-12(n), plurality of data servers 16(1)-16(n) coupled via one or more communication networks 18, although the environment could include other types and numbers of systems, devices, components, and/or other elements as is generally known in the art and will not be illustrated or described herein. This technology provides a number of advantages including providing methods, non-transitory computer readable medium, and apparatuses that provide predictive estimation of repair lines based on historical data.

Referring more specifically to FIGS. 1-2, the valuation management computing apparatus 14 is programmed to provide predictive estimation of repair lines based on historical data, although the apparatus can perform other types and/or numbers of functions or other operations and this technology can be utilized with other types of claims. In this particular example, the valuation management computing apparatus 14 includes a processor 18, a memory 20, and a communication system 24 which are coupled together by a bus 26, although the valuation management computing apparatus 14 may comprise other types and/or numbers of physical and/or virtual systems, devices, components, and/or other elements in other configurations.

The processor 18 in the valuation management computing apparatus 14 may execute one or more programmed instructions stored in the memory 20 for improving the accuracy of automated vehicle valuations as illustrated and described in the examples herein, although other types and numbers of functions and/or other operations can be performed. The processor 18 in the valuation management computing apparatus 14 may include one or more central processing units and/or general purpose processors with one or more processing cores, for example.

The memory 20 in the valuation management computing apparatus 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

The communication system 24 in the valuation management computing apparatus 14 operatively couples and communicates between one or more of the agent computing devices 12(1)-12(n) and one or more of the plurality of data servers 16(1)-16(n), which are all coupled together by one or more of the communication networks 30, although other types and numbers of communication networks or systems with other types and numbers of connections and configurations to other devices and elements may be utilized. By way of example only, the communication networks 18 can use TCP/IP over Ethernet and industry-standard protocols, including NFS, CIFS, SOAP, XML, LDAP, SCSI, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

In this particular example, each of the agent computing devices 12(1)-12(n) may submit requests for vehicle valuations associated with an insurance claim which require an automated vehicle valuation by the valuation management computing apparatus 14, although the requests for vehicle valuations can be obtained by the valuation management computing apparatus 14 in other manners and/or from other sources. Each of the agent computing devices 12(1)-12(n) may include a processor, a memory, user input device, such as a keyboard, mouse, and/or interactive display screen by way of example only, a display device, and a communication interface, which are coupled together by a bus or other link, although each may have other types and/or numbers of other systems, devices, components, and/or other elements.

The plurality of data servers 16(1)-16(n) may store and provide historical data associated with the parts and labor usage, model, make, year, specific configuration, trim level of a vehicle, optional equipment, data associated with original equipment manufacturer, by way of example only, to the valuation management computing apparatus 14 via one or more of the communication networks 30, for example, although other types and/or numbers of storage media in other configurations could be used. In this particular example, each of the plurality of data servers 16(1)-16(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the plurality of data servers 16(1)-16(n) and may transmit data in response to requests from the valuation management computing apparatus 14. Each the plurality of data servers 16(1)-16(n) may include a processor, a memory, and a communication interface, which are coupled together by a bus or other link, although each may have other types and/or numbers of other systems, devices, components, and/or other elements.

Although the exemplary network environment 10 with the valuation management computing apparatus 14, the agent computing devices 12(1)-12(n), the plurality of data servers 16(1)-16(n), and the communication networks 30 are described and illustrated herein, other types and numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices, apparatuses, and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

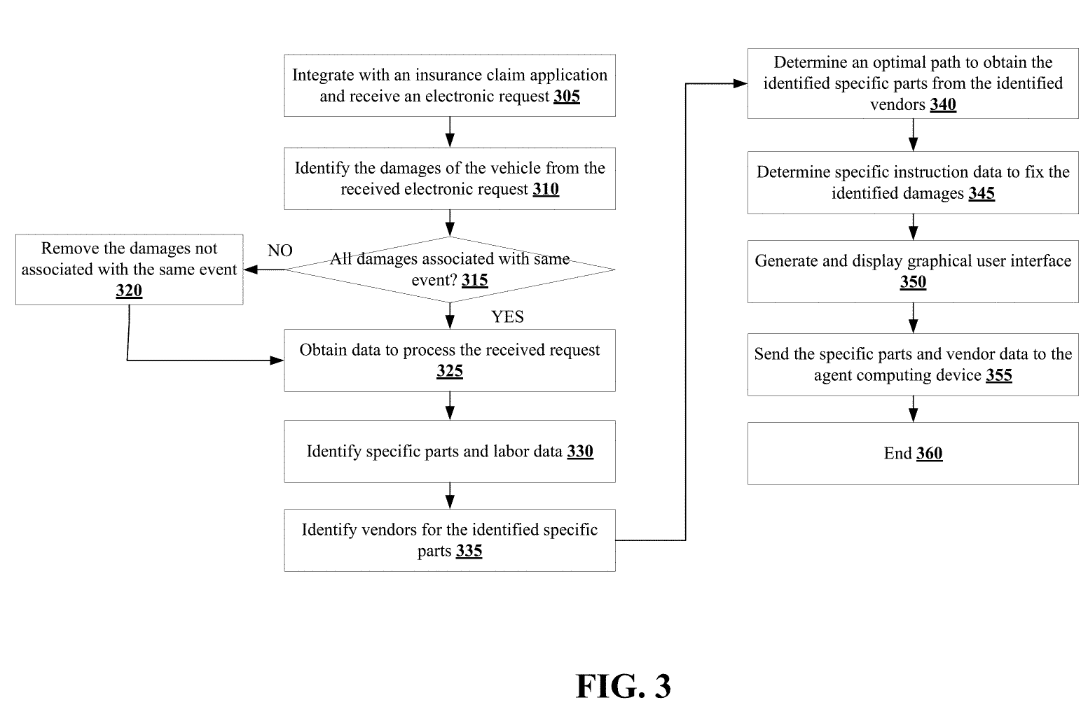

An example of a method for predictive estimation of repair lines based on historical data will now be described with reference to FIGS. 1-7. In particular, referring to FIG. 3 the exemplary method begins at step 305 where the valuation management computing apparatus 14 may integrate with at least one insurance claim application executed by a requesting one of the agent computing device 12(1)-12(n) to initiate an automated valuation in response to an electronic request for an insurance claim for a claim vehicle, although the predictive estimation of repair lines based on historical data can be initiated in other manners. In this example, the received electronic request for the insurance claim includes a notice of loss of the vehicle that currently has damage comprising one or more defects from an accident (or an event) along with one or more images and videos of the damage, although the received request can include other types or amounts of data. Additionally in this example, the valuation management computing apparatus 14 can obtain the diagnostic vehicle data of the damaged vehicle by connecting via the communication network 30 to multiple sensors embedded in the damaged vehicle, although the valuation management computing apparatus 14 can use other techniques to obtain the diagnostic vehicle data.

In step 310, the valuation management computing apparatus 14 processes the received request along with the data to identify the specific defects from the damage to the vehicle. By way of example, the valuation management computing apparatus 14 scans the received images and videos of the damage to identify a location and a nature of each defect that is visible. The valuation management computing apparatus 14 also is able to analyze the diagnostic vehicle data to automatically identify any defects from the damage that are not visible in the images and the videos by correlating the visible defects to the possible defects that are not visible based on historical data.

Next in step 315, the valuation management computing apparatus 14 determines if each of the identified defects are new or existing defects. By way of example, the valuation management computing apparatus 14 may scan the received photos, videos and the diagnostic data including historical data to identify any new defects from the damage as opposed to already existing defects in the vehicle. Accordingly, when the valuation management computing apparatus 14 determines that at least one of the identified defects is new, then the No branch is taken to step 320.

In step 320, the valuation management computing apparatus 14 separates or removes any data relating to existing defects and then retains the data for any new defect from the new damage.

However if back in step 315 the valuation management computing apparatus 14 determines that the identified defects are associated with the same accident or event, then the Yes branch is taken to step 325.

In step 325, the valuation management computing apparatus 14 obtains the historical parts and labor data associated with the new defects from the plurality of data servers 16(1)-16(n), although the valuation management computing apparatus 14 can obtain the data from other locations. In this example, the vehicle input data includes the historical data associated with the original equipment manufacture, metadata of point of impact (date of impact, time of impact etc), and data from the industry experts, although the vehicle input data can include other types or amounts of information. By using this technique, the technology is able to automatically retrieve the parts and labor related data that were used to fix damage(s) similar to the identified damages without requiring any user intervention.

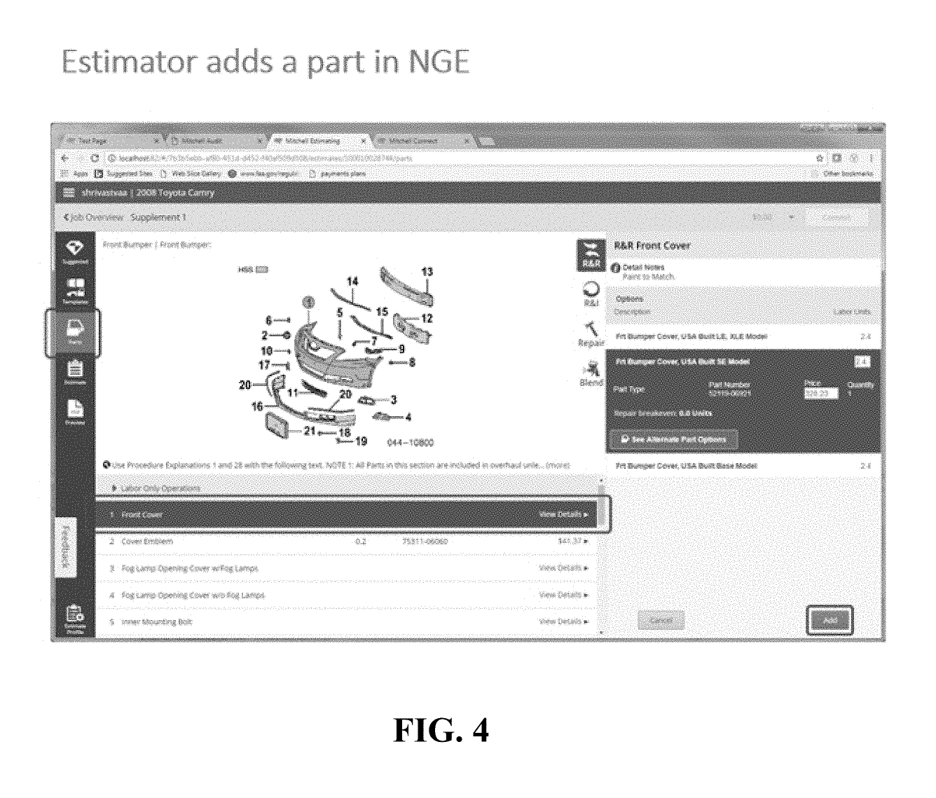

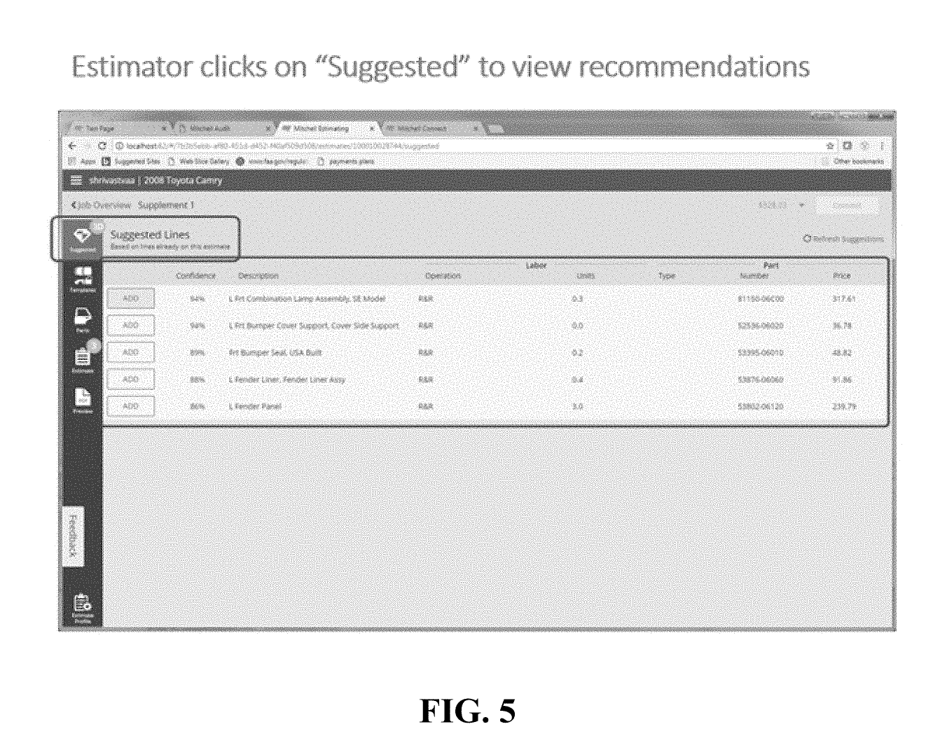

Next in step 330, the valuation management computing apparatus 14 identifies specific parts and labor process required to fix the identified damages from the obtained historical parts and labor data (including labor cost and labor time). By way of example, FIGS. 4-5 provide an exemplary illustration of the identified specific parts. Optionally, the valuation management computing apparatus 14 can use one or more product rules while identifying the specific parts and the labor process. Examples of the product rules includes, parts specific to the model, make, year of the vehicle, or a minimum and maximum cost of the specific parts, although other types of rules can be applied while identified the specific parts.

In step 335, the valuation management computing apparatus 14 identifies vendors having the identified specific parts available based on the historical data, although the vendors can be identified by using data from a vendor database. Alternatively, the vendors can be identified in real-time by using application programming interface (API). Optionally, the valuation management computing apparatus 14 can apply one or more vendor rules while identifying the vendors having the identified specific parts. By way of example, the valuation management computing apparatus 14 can identify the vendors based on vendor rules based on a proximity setting rule, e.g. with five miles of the location of the damaged vehicle and on vendor reviews above a stored threshold provided by previous customers of the vendors, although the valuation management computing apparatus 14 can use other types and/or numbers of rules to identify each necessary vendor.

Next in step 340, the valuation management computing apparatus 14 determines an optimal path to obtain the identified specific parts from the identified vendors. In this example, the valuation management computing apparatus 14 also can provide real-time navigation instructions to obtain the identified specific parts from the identified vendors. By way of example, an optimal path includes the shortest path that can be taken considering the distance or time to obtain the identified specific parts from the identified vendors. The valuation management computing apparatus 14 can further dynamically update the determined optimal path once the path is being traversed.

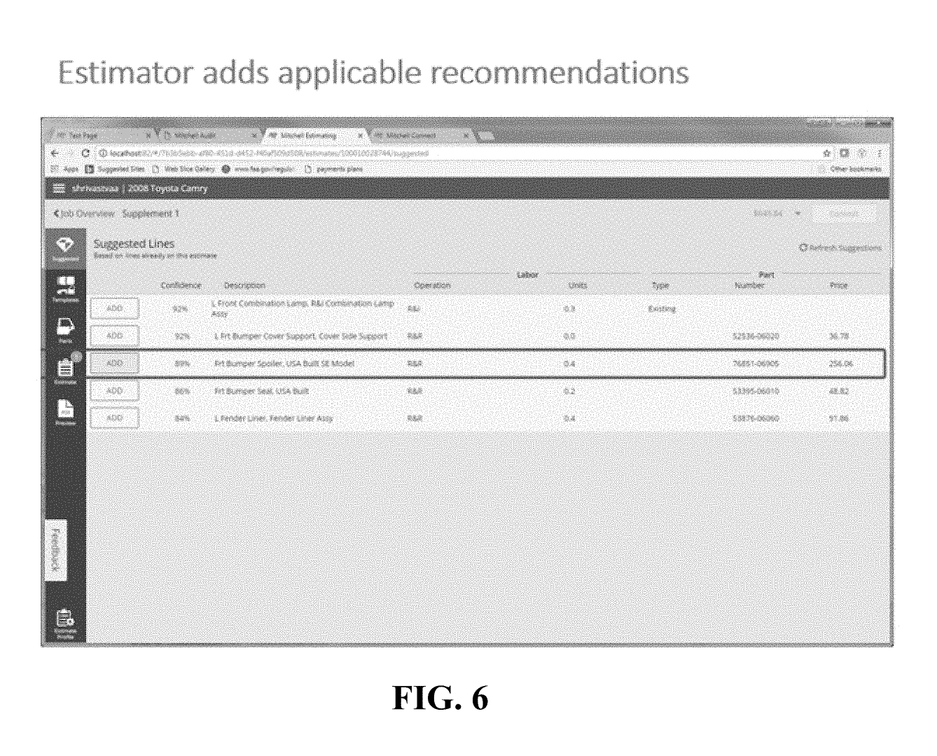

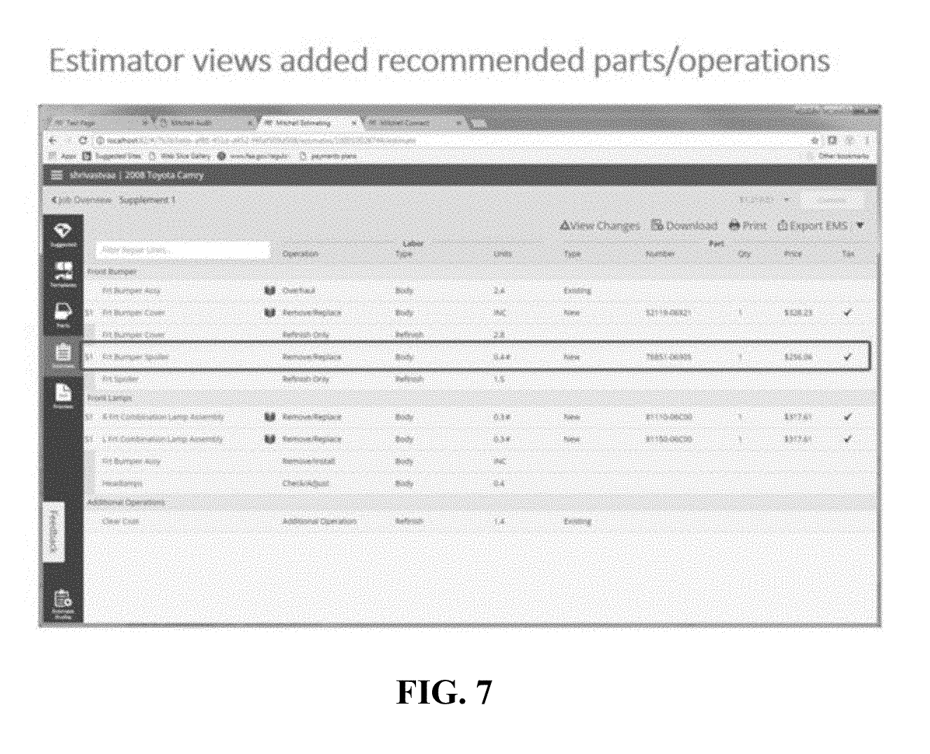

In step 345, the valuation management computing apparatus 14 generates specific instruction data to fix the identified defects using the identified specific parts. In this example, the valuation management computing apparatus 14 can obtain data from the product or installation manuals associated with the identified specific parts to provide the specific instruction data to fix the identified defects. Additionally, the valuation management computing apparatus 14 can include an estimate of the labor time (hours) and labor cost required to fix the damages along with the specific instruction data based on historical data, although other techniques can be used to provide an estimate of the labor time hours and the labor cost. Further, the valuation management computing apparatus 14 can include the technical description of the each of the identified specific parts as illustrated in FIGS. 6-7.

In step 350, the valuation management computing apparatus 14 displays the specific instruction data, the identified specific parts, and identified vendor(s) in a graphical user interface as illustrated in FIGS. 6-7. In this example, the valuation management computing apparatus 14 creates and displays a graphical user interface with the identified defects and the identified specific parts, although the graphical user interface can include other types or amounts of information.

In step 355, the valuation management computing apparatus 14 sends the specific parts data, the vendor data and the specific instruction data to the requesting one of the plurality of agent computing devices 12(1)-12(n) as a response to the received request in step 305. Optionally, the valuation management computing apparatus 14 can also send the optimal path with the navigational data to the requesting one of the plurality of agent computing devices 12(1)-12(n). The exemplary method ends at step 360.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for providing predictive estimates of repair lines, the method comprising:
receiving, by a valuation management computing apparatus, vehicle damage data comprising images, videos, and vehicle diagnostic data;
identifying, by the valuation management computing apparatus, one or more defects based on the received vehicle damage data by analyzing the received images and videos;
determining, by the valuation management computing apparatus, one or more repair parts data and labor data for the identified one or more damages based on historical repair parts data and historical labor data;
providing, by the valuation management computing apparatus, the determined one or more repair parts data and the labor data.

2. The method as set forth in claim 1 further comprising, identifying, by the valuation management computing apparatus, vendor data for one or more vendors for the determined one or more repair parts data based on one or more vendor rules.

3. The method as set forth in claim 1 wherein at least one of the identified one or more defects is not visible in the received plurality of images and videos.

4. The method as set forth in claim 1 further comprising, determining, by the valuation management computing apparatus, an optimal path to obtain the determined one or more repair parts from the identified one or more vendor data.

5. The method as set forth in claim 1 further comprising, generating, by the valuation management computing apparatus, specific instruction data to fix the identified one or more defects using the determined one or more repair parts.

6. The method as set forth in claim 1 wherein the graphical user interface is comprises the identified one or more damages, determined one or more repair parts data and the labor data.

7. A non-transitory computer readable medium having stored thereon instructions for providing predictive estimates of repair lines, comprising executable code, which when executed by at least one processor, cause the processor to:
receive vehicle damage data comprising images, videos, and vehicle diagnostic data;
identify one or more defects based on the received vehicle damage data by analyzing the received images and videos;
determine one or more repair parts data and labor data for the identified one or more damages based on historical repair parts data and historical labor data;
provide the determined one or more repair parts data and the labor data.

8. The medium as set forth in claim 7 wherein the executable code, when executed by the processor, further causes the processor to identify one or more vendor data for the determined one or more repair parts data based on one or more vendor rules.

9. The medium as set forth in claim 7 wherein at least one of the identified one or more damages is not visible in the received plurality of images and videos.

10. The medium as set forth in claim 7 wherein the executable code, when executed by the processor, further causes the processor to determine an optimal path to obtain the determined one or more repair parts from the identified one or more vendor data.

11. The medium as set forth in claim 7 wherein the executable code, when executed by the processor, further causes the processor to generate specific instruction data to fix the identified one or more damages using the determined one or more repair parts.

12. The medium as set forth in claim 7 wherein the graphical user interface is generated based on the identified one or more damages, determined one or more repair parts data and the labor data.

13. A valuation management computing apparatus comprising:
a processor; and
a memory coupled to the processor which is configured to be capable of executing programmed instructions comprising and stored in the memory to:
receive vehicle damage data comprising images, videos, and vehicle diagnostic data;
identify one or more defects based on the received vehicle damage data by analyzing the received images and videos;
determine one or more repair parts data and labor data for the identified one or more damages based on historical repair parts data and historical labor data;
provide the determined one or more repair parts data and the labor data.

14. The apparatus as set forth in claim 13 wherein the processor is further configured to be capable of executing the stored programmed instructions to identify one or more vendor data for the determined one or more repair parts data based on one or more vendor rules.

15. The apparatus as set forth in claim 13 wherein at least one of the identified one or more damages is not visible in the received plurality of images and videos.

16. The apparatus as set forth in claim 13 wherein the processor is further configured to be capable of executing the stored programmed instructions to determine an optimal path to obtain the determined one or more repair parts from the identified one or more vendor data.

17. The apparatus as set forth in claim 13 wherein the processor is further configured to be capable of executing the stored programmed instructions to generate specific instruction data to fix the identified one or more damages using the determined one or more repair parts.

18. The apparatus as set forth in claim 13 wherein the graphical user interface is generated based on the identified one or more damages, determined one or more repair parts data and the labor data.
